(19) United States
(12) Patent Application Publication
(10) Pub. No.: US 2026/0058550 A1
(43) Pub. Date: Feb. 26, 2026

(54) CHARGE PUMP VOLTAGE REGULATOR CIRCUIT

(71) Applicant: Hangzhou HFC Semiconductor Co., Hangzhou (CN)

(72) Inventors: Zhichao GUO, Hangzhou (CN); Wanxin SHAO, Hangzhou (CN); Weiwei WANG, Hangzhou (CN); Shanpeng JI, Hangzhou (CN); He HE, Hangzhou (CN); Haiping SONG, Hangzhou (CN)

(21) Appl. No.: 18/901,759

(22) Filed: Sep. 30, 2024

(30) Foreign Application Priority Data
Aug. 20, 2024 (CN) 202411141127.5

(51) Int. Cl. H02M 3/07

(52) U.S. Cl. CPC H02M 3/07

(57) ABSTRACT

A charge pump voltage regulator circuit is provided. The charge pump voltage regulator circuit includes: an oscillating frequency source circuit for providing multiple oscillating frequencies; a Mux circuit for receiving the oscillating frequencies and a control signal, selecting one of the oscillating frequencies as a driving clock frequency based on a value of the control signal and outputting the driving clock frequency, wherein each oscillating frequency corresponds to a corresponding value of the control signal; a charge pump for raising an input voltage to a value corresponding to the driving clock frequency and outputting a voltage; a voltage divider circuit for dividing the voltage output from the charge pump to obtain multiple divided voltages; and a comparator circuit for comparing each divided voltage with a reference voltage to obtain multiple comparison values, which are taken as the control signal for the Mux circuit.

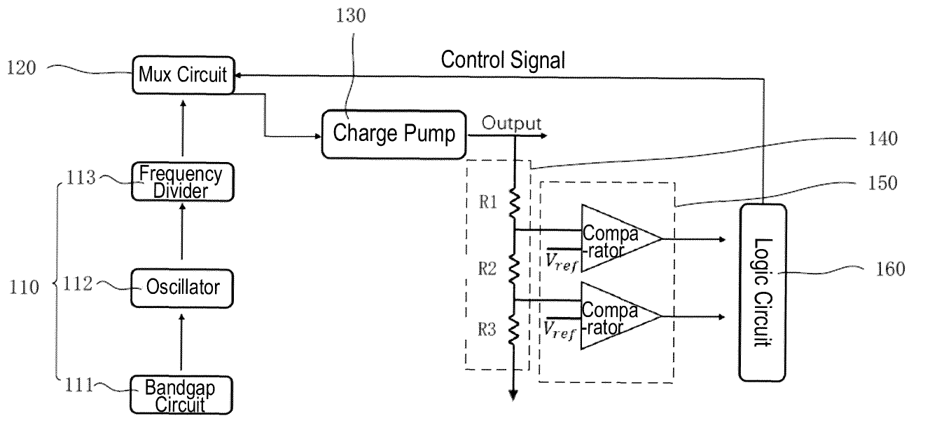

### CROSS-REFERENCE TO RELATED APPLICATION

This application claims the priority of Chinese patent application number 202411141127.5, filed on Aug. 20, 2024 and entitled “CHARGE PUMP VOLTAGE REGULATOR CIRCUIT”, the entire contents of which are incorporated herein by reference.

### TECHNICAL FIELD

The present invention relates to the field of integrated circuits, and particularly to a charge pump voltage regulator circuit.

### BACKGROUND

In NOR, NAND and other flash memory devices, charge pumps are used to provide different voltages for read, write and erase operations of flash memory cells. A charge pump must be designed to provide a desired voltage even under the worst PVT (Process, Voltage, Temperature) conditions. This causes a possibly higher voltage than desired from the charge pump under other operating conditions, which may adversely affect the basic properties and reliability of flash memory cells. Stable voltages can be obtained from a charge pump by adding a voltage regulator circuit to its output.

According to the working principles of charge pumps, the output voltage of a charge pump can be adjusted by changing its power supply voltage VDD, number N and capacitances C of capacitor stages, load current Iₒᵤₜ or driving clock frequency f. Conventionally, this is commonly accomplished by changing the load current or the driving clock frequency. In the former approach, when the output voltage of the charge pump rises above a specified value, the output of the charge pump is grounded to discharge unwanted electricity to the ground. Specifically, the output voltage of the charge pump may be divided, and a resulting divided voltage may be input to a comparator to compare it with a reference voltage. If the divided voltage is higher than the reference voltage, the comparator may output a high level to turn on an NMOS transistor, allowing the undesired electric charge to be discharged from the charge pump to the ground in the form of a large discharge current. As a result, the output voltage of the charge pump will be pulled down to a desired lower level. In the latter approach, a comparison made between the output voltage and a reference voltage serves as a basis for enabling and disabling of a driving clock frequency. If the comparison indicates that the output voltage is undesirably high, the driving clock frequency is disabled, causing the charge pump to start discharging. If the output voltage is found to be drop below the reference voltage, the driving clock frequency is enabled and the charge pump is restarted and attains normal operation. In this way, the output voltage of the charge pump can be regulated.

However, the first conventional approach is problematic in that directly grounding the output of the charge pump interrupts provision of the output voltage and may thus add ripple to the subsequent output voltage of the charge pump. In the second conventional approach, since the clock frequency is frequently enabled and disabled, the charge pump operates only in either of the discharging and normal conditions. This may result in poor voltage regulation accuracy of the output voltage of the charge pump, long restart times of the charge pump, and instability of the output voltage of the charge pump.

### SUMMARY OF THE INVENTION

It is an object of the present invention to provide a charge pump voltage regulator circuit, which enables the charge pump to provide a more accurately regulated output voltage with less ripple.

To this end, the present invention provides a charge pump voltage regulator circuit comprising:
an oscillating frequency source circuit configured to provide a plurality of oscillating frequencies;
a Mux circuit configured to receive the plurality of oscillating frequencies and a control signal, wherein each oscillating frequency corresponds to a value of the control signal, and the Mux circuit is further configured to select one of the oscillating frequency as a driving clock frequency based on the corresponding value of the control signal and to output the driving clock frequency;
a charge pump configured to raise its input voltage to a voltage corresponding to the driving clock frequency and output a voltage;
a voltage divider circuit configured to divide the voltage output from the charge pump to obtain a plurality of divided voltages; and
a comparator circuit configured to compare each divided voltage with a reference voltage to obtain a number of comparison values which are taken as the control signal for the Mux circuit.

According to the present invention, the control signal is used to select one of the driving clock frequencies, enabling the charge pump to output different voltages. This reduces ripple in, and enables more accurate regulation of, the output voltage of the charge pump.

### BRIEF DESCRIPTION OF THE DRAWINGS

The sole FIGURE schematically depicts a charge pump voltage regulator circuit according to embodiments of the present invention, in which:
110, an oscillating frequency source circuit; 111, a bandgap circuit; 112, an oscillator; 113, a frequency divider; 120, a Mux circuit; 130, a charge pump; 140, a voltage divider circuit; 150, a comparator circuit; and 160, a logic circuit.

### DETAILED DESCRIPTION

Specific embodiments of the present invention will be described in greater detail below with reference to the annexed schematic diagram. From the following description, advantages and features of the present invention will be more apparent. Note that the FIGURE is provided in a very simplified form not necessarily drawn to exact scale for the only purpose of helping to explain the disclosed embodiments in a more convenient and clearer way.

As used hereinafter, the terms “first”, “second” and the like may be used to distinguish between similar elements without necessarily implying any particular ordinal or chronological sequence. It will be understood that the terms so used are interchangeable, whenever appropriate. Likewise, if a method is described herein as comprising a series of steps, the order of these steps as presented herein is not necessarily the only order in which they can be performed, and certain ones of the stated steps may be possibly omitted and/or certain other steps not described herein may be possibly added to the method.

It will be understood that when a layer (or film), region, pattern or structure is referred to as being “above” a substrate, other layer (or film), region and/or pattern, it may be directly on the other layer or substrate, or intervening layer(s) may also be present. It will also be understood that when a layer is referred to as being “under” another layer, it may be directly under or below the other layer, or one or more intervening layers may also be present. Further, reference to a layer being “above” or “under” another layer is made herein based on the orientation of the accompanying drawing.

Reference is now made to the sole FIGURE. The present invention provides a charge pump voltage regulator circuit including:
an oscillating frequency source circuit 110 for providing a number of oscillating frequencies;
a multiplexer (Mux) circuit 120 for receiving the oscillating frequencies and a control signal, selecting one of the oscillating frequencies as a driving clock frequency based on a value of the control signal and outputting the driving clock frequency, wherein each of the oscillating frequencies corresponds to a value of the control signal;
a charge pump 130 comprising an input voltage terminal and an output voltage terminal, the charge pump 130 configured to receive VDD as an input voltage, to raise the input voltage to a value according to the driving clock frequency from the Mux circuit 120 and to output a voltage;
a voltage divider circuit 140 for dividing the voltage output from the charge pump and thereby obtaining a number of divided voltages; and
a comparator circuit 150 for comparing each of the divided voltages with a reference voltage and thereby obtaining a number of comparison values, wherein the comparison values are taken as the control signal for the Mux circuit.

According to embodiments of the present invention, the oscillating frequency source circuit 110 may include: a bandgap circuit 111 for providing a voltage reference which is used as a bias by an oscillator 112; the oscillator 112, which is configured to produce a clock pulse signal based on the bias provided by the voltage reference; and a frequency divider 113 for converting the clock pulse signal into a number of different oscillating frequencies. The frequency divider 113 may subject the clock pulse signal to frequency division by two, four and eight, producing clock signals of different frequencies. According to embodiments of the present invention, the voltage reference provided by the bandgap circuit 111 may be used as the reference voltage Vref for the comparator circuit and may be about 1.8 V. Those skilled in the art know how the bandgap circuit 111 provides the reference voltage Vref, and further description thereof is omitted herein.

According to embodiments of the present invention, the charge pump voltage regulator circuit may further include a logic circuit 160 for performing logic calculations on the comparison values from the comparator circuit before they are taken as the control signal of the Mux circuit 120. According to embodiments of the present invention, the logic circuit 160 may combine the comparison values from the comparators into a single value which is more intuitive and easier to handle, and this value can be taken as the control signal. According to embodiments of the present invention, the control signal may be a digital signal.

According to embodiments of the present invention, the Mux circuit 120 may comprise two input terminals for respectively receiving the oscillating frequencies and the control signal. One of the oscillating frequencies may be selected as a driving clock frequency based on a value of the control signal, then outputting the driving clock frequency. Each of the oscillating frequencies may correspond to a value of the control signal. Such correspondence may be stored in a table. For example, in case of two comparators being included, the comparison values from the comparators may be “0” and “0”, “0” and “1”, “1” and “0”, or “1” and “1”. The logic circuit 160 may combine them into “00”, “01”, “10” or “11”, respectively, which is then used as the control signal for the Mux circuit. Therefore, according to embodiments of the present invention, the control signal may comprise one of multiple possible values. When the value of the control signal received at the Mux circuit 120 is “00”, a driving clock frequency corresponding to “00” may be selected. When the value of the control signal received at the Mux circuit 120 is “01”, another driving clock frequency corresponding to “01” may be selected. Similarly, when the value of the control signal received at the Mux circuit 120 is “10” or “11”, a further driving clock frequency corresponding to “10” or “11” may be selected. Depending on the selected driving clock frequency, the input voltage of the charge pump may be raised to a suitable level, and the raised voltage may be output as the output voltage of the charge pump. The correspondence between the possible values of the control signal and the driving clock frequencies, as well as the correspondence between the driving clock frequencies and the raised voltages of the charge pump, may be set as required in practical applications.

According to embodiments of the present invention, the voltage divider circuit may include first to N-th resistors, which are sequentially connected in series between the output voltage of the charge pump and the ground. A divided voltage may be obtained at a terminal of each of the first to (N−1)-th resistors closer to the ground. N is a positive integer greater than or equal to 3. In an exemplary embodiment of the present invention, 3 resistors are included, i.e., N=3. The three resistors may each have a resistance ranging from 1 kΩ to 10 kΩ. Of course, in other embodiments of the present invention, different resistance ranges are also possible. The 3 resistors, namely, a first resistor R1, a second resistor R2 and a third resistor R3, may be sequentially connected in series between the output voltage of the charge pump and the ground. That is, a first terminal of the first resistor R1 is connected to the output of the charge pump 130, a second terminal of the first resistor R1 is connected to a first terminal of the second resistor R2, a second terminal of the second resistor R2 is connected to a first terminal of the third resistor R3, and a second terminal of the third resistor R3 is grounded. Two divided voltages are obtained respectively at the second terminal of the first resistor R1 and at the second terminal of the second resistor R2. In other embodiments of the present invention, N may be another value than 3, and may be determined as required in practical applications.

According to embodiments of the present invention, the comparator circuit may include (N−1) comparators, each having an input terminal connected to a divided voltage, another input terminal connected to the reference voltage and an output terminal from which a comparison value is output. In an exemplary embodiment of the present invention, two comparators are included. In this case, one input terminal of one comparator is coupled to one of the aforementioned divided voltages, and the other input terminal of the comparator is coupled to the reference voltage. In the other comparator, one input terminal is coupled to the other divided voltage, and the other input terminal is coupled to the reference voltage. The same reference voltage generated by the bandgap circuit 111 is received at the input terminal of each comparator. For each comparator, if the divided voltage is higher than or equal to the reference voltage, “1” is output; otherwise, if the divided voltage is lower than the reference voltage, “0” is output. Therefore, in case of two comparators being included, “0” or “1” may be output by each comparator, corresponding to 4 possible values of the control signal. With this arrangement, less ripple is present in the output voltage of the charge pump, in comparison with the conventional approach that relies on directly grounding of the output of the charge pump for discharge of unwanted electric charge in the form of a current, which interrupts the provision of the output voltage. Moreover, the charge pump according to embodiments of the present invention allows for more stable voltage rises, a more stable output voltage and higher regulation accuracy, compared with the conventional approach that stops operation of the charge pump by directly interrupting the provision of a driving clock frequency. Further, according to embodiments of the present invention, it is unnecessary to restart the charge pump, saving the time required for such restarting.

In summary, embodiments of the present invention provide a charge pump voltage regulator circuit comprising: an oscillating frequency source circuit for providing a number of oscillating frequencies; a Mux circuit for receiving the oscillating frequencies and a control signal, selecting one of the oscillating frequencies as a driving clock frequency based on a value of the control signal and outputting the driving clock frequency, wherein each of the oscillating frequency corresponds to a value of the control signal; a charge pump for raising an input voltage to a value corresponding to the driving clock frequency and outputting the voltage; a voltage divider circuit for dividing the voltage output from the charge pump and thereby obtaining a number of divided voltages; and a comparator circuit for comparing each divided voltage with a reference voltage and thereby obtaining a number of comparison values, which are taken as the control signal for the Mux circuit. According to the present invention, the control signal is used to select one of the driving clock frequencies, enabling the charge pump to output different voltages. This reduces ripple in, and enables more accurate regulation of, the output voltage of the charge pump.

Presented above are merely some preferred embodiments of the present invention, which do not limit the invention in any way. Changes in any forms made to the principles and teachings disclosed herein, including equivalents and modifications, by any person of ordinary skill in the art without departing from the scope of the invention are intended to fall within the scope of the invention.

What is claimed is:

1. A charge pump voltage regulator circuit, comprising:
an oscillating frequency source circuit configured to provide a plurality of oscillating frequencies;
a multiplexer (Mux) circuit configured to receive the plurality of oscillating frequencies and a control signal, wherein each oscillating frequency corresponds to a value of the control signal, and wherein the Mux circuit is further configured to select one of the oscillating frequencies as a driving clock frequency based on a corresponding value of the control signal and to output the driving clock frequency;
a charge pump configured to raise an input voltage thereof to a voltage corresponding to the driving clock frequency and to output a voltage;
a voltage divider circuit configured to divide the voltage output from the charge pump to obtain a plurality of divided voltages; and
a comparator circuit configured to compare each of the plurality of divided voltages with a reference voltage to obtain a plurality of comparison values, wherein the comparison values are taken as the control signal for the Mux circuit.

2. The charge pump voltage regulator circuit of claim 1, further comprising a logic circuit configured to perform logic calculations on the comparison values before they are taken as the control signal for the Mux circuit.

3. The charge pump voltage regulator circuit of claim 1, wherein the oscillating frequency source circuit comprises:
a bandgap circuit for providing a voltage reference;
an oscillator for generating a clock pulse signal based on a bias provided by the voltage reference; and
a frequency divider for converting the clock pulse signal into the plurality of oscillating frequencies.

4. The charge pump voltage regulator circuit of claim 3, wherein the bandgap circuit is further configured to provide the reference voltage.

5. The charge pump voltage regulator circuit of claim 1, wherein the control signal is a digital signal.

6. The charge pump voltage regulator circuit of claim 1, wherein the voltage divider circuit comprises a first resistor to an N-th resistor which are sequentially connected in series between the output voltage of the charge pump and a ground, wherein a divided voltage is obtained at a terminal of each of the first to (N−1)-th resistors closer to the ground, and N is a positive integer greater than or equal to 3.

7. The charge pump voltage regulator circuit of claim 6, wherein each of the first to N-th resistors comprises a resistance ranging from 1 kΩ to 10 kΩ.

8. The charge pump voltage regulator circuit of claim 7, wherein the comparator circuit comprises (N−1) comparators, wherein each comparator comprises: a first input terminal coupled to a corresponding divided voltage; a second input terminal coupled to a reference voltage; and an output terminal from which a corresponding comparison value is output.

9. The charge pump voltage regulator circuit of claim 8, wherein the second input terminal of each comparator is coupled to a same reference voltage.

10. The charge pump voltage regulator circuit of claim 8, wherein the comparator outputs “1” if the divided voltage is greater than or equal to the reference voltage, or outputs “0” if the divided voltage is lower than the reference voltage.
